(19) United States
(12) Patent Application Publication
(10) Pub. No.: US 2005/0227697 A1
(43) Pub. Date: Oct. 13, 2005

(54) Method and apparatus for channel prediction in wireless networks

(75) Inventors: Simon C. Borst, Convent Station, NJ (US); Piyush Gupta, Piscataway, NJ (US); Philip A. Whiting, New Providence, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ (US)

(21) Appl. No.: 10/822,511

(22) Filed: Apr. 12, 2004

(51) Int. Cl. H04Q 7/20

(52) U.S. Cl. 455/450

(57) ABSTRACT

Techniques and systems for channel prediction in wireless networks. A base station receives a succession of channel indicators from each of a plurality of mobile units, each channel indicator being received from each mobile unit once per timeslot. A channel predictor uses the channel indicators to generate a channel condition prediction for each mobile unit, the channel condition prediction being based on a balanced estimate using the most recent channel condition indicator and the mean of the succession of channel indicators. A weight is computed based on a gradient of the succession channel indicator values and used to assign relative emphasis to the most recent channel condition indicator and the mean channel condition indicator in order to give greater emphasis to the most recent indicator during slowly changing conditions and greater emphasis to the mean indicator during rapidly changing conditions.

### FIELD OF THE INVENTION

The present invention relates generally to improved systems and methods for operation of wireless networks. More particularly, the invention relates to advantageous techniques for predicting channel qualities and the use of predictions of channel qualities in operations such as rate selection and transmission scheduling.

### BACKGROUND OF THE INVENTION

As wireless services continue to develop, data communication is becoming a more and more important part of the services. Important elements and services needed for wireless data communication include channel estimation and prediction, scheduling, coding rate and modulation selection and hybrid automatic repeat request (HARQ).

Of particular interest is channel prediction, because channel prediction is important for use in scheduling. A base station chooses which mobile unit to serve based in significant part on the quality of the channel as experienced by the mobile units. Typically, transmission of data will not occur at the instant that information about the channel quality is available. The channel quality must be detected by the mobile unit and reported to the base station, and then the base station must prepare and send the transmission. In addition, it may not be desired to transmit to a particular mobile unit at the exact moment that information relating to the channel condition is received. A base station may be transmitting to four different mobile units, for example, and transmission to the fourth mobile unit may occur some time after channel condition information is received. Thus, the channel condition may undergo significant changes between the time the base station receives channel information and the time transmission is received at a particular mobile unit. Therefore, channel prediction is used to allow estimation of the channel quality that will be experienced at a mobile unit at the time transmission is actually made to the mobile unit.

A channel predictor receives channel information in the form of digitized signal to noise (SNR) reports from a mobile unit. The channel predictor computes useful information from these reports, such as short term means of past conditions, predictions of present or future channel conditions and error estimates, and provides this information to a scheduler. The scheduler considers this information, along with such information as available resources and quality of service requirements, in determining which mobile unit or group of mobile units to serve next, as well as how to allocate power among the mobile units to be served. The scheduler also sets the modulation and coding rate for each of the mobile units served in such a way as to maximize throughput while maintaining an acceptable target frame error rate.

In a typical wireless environment, a channel predictor encounters a potentially wide range of fading and path loss scenarios. At one extreme, the channel may be changing slowly at a frequency of only a few hertz (Hz). In such cases, reliable predictions can typically be made. At the other extreme, fading may be rapid at a frequency of tens of Hz or more. In cases where fading and other changes are occurring rapidly, channel quality prediction beyond the short term mean is difficult.

It is highly desirable for a predictor to be able to adapt between the above two extreme scenarios. In addition, it will generally be highly desirable to be able to provide predictions of a channel quality occurring at each of several time intervals, because a codeword may take multiple intervals to be transmitted. In order to provide reliable and accurate service, a predictor should preferably exhibit numerical robustness, and should preferably perform reasonably well in most environments, rather than give exceptional service in some environments but limited performance in others. In addition, a predictor should provide a measure of error for the prediction. A predictor should also exhibit numerical simplicity, so as to avoid increasing the computational load on wireless network components, such as application specific integrated circuits (ASICs), which may have limited capacity for performing complex numerical applications.

There exists, therefore, a need for systems and techniques for channel quality prediction that provide reasonable performance for a wide range of channel conditions, and which also exhibit computational simplicity and robustness.

### SUMMARY OF THE INVENTION

A wireless telephone network according to an aspect of the present invention includes at least one base station, each base station being capable of serving a plurality of mobile units. Each mobile unit periodically sends a feedback signal to the base station, with the feedback signal including information indicating the channel condition being experienced by the mobile unit. A feedback signal may suitably be sent to the base station once every timeslot, where a timeslot is a time interval during which transmission or reception occurs, with the duration of the timeslot being defined by the standard under which the network is operating. The base station collects and stores past channel condition information values for each mobile unit.

In order to schedule transmission for efficient throughput and to manage operations necessary for transmission, such as encoding of data and setting of data units that can be transmitted during a timeslot, the base station makes predictions about the channel condition that will be experienced by each mobile unit when transmission is performed. Transmission by the base station to a mobile unit will be separated by some lag from the most recent channel condition information available for that mobile unit. For a slowly changing channel, the best prediction performance is provided by specific channel condition prediction based on recent channel condition values, while in a rapidly changing channel, better prediction performance is provided by taking the mean of the sequence of channel condition values that occurred over time. When making channel predictions, therefore, the base station computes the mean of the sequence of channel condition values and computes the channel condition prediction in such a way as to assign a greater weight to specific predictions when a channel is changing slowly and a greater weight to the mean value of the overall sequence when a channel is changing rapidly. The weight is computed based on the gradient of the prediction error with respect to the weight.

A more complete understanding of the present invention, as well as further features and advantages, will be apparent from the following Detailed Description and the accompanying drawings.

### BRIEF DESCRIPTION OF THE DRAWINGS

FIG. 1 illustrates a wireless telephone system comprising a channel predictor according to an aspect of the present invention;

FIG. 2 illustrates additional details of a channel predictor according to an aspect of the present invention;

FIG. 3 illustrates a graph showing the relationship of prediction error results against the variable w for various fading frequencies at a lag of 5 timeslots;

FIG. 4 illustrates a graph showing the relationship of prediction error results against the variable w for various fading frequencies at a lag of 25 timeslots; and

FIG. 5 illustrates a process of channel prediction and transmission scheduling according to an aspect of the present invention.

### DETAILED DESCRIPTION

The present invention will be described more fully hereinafter with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

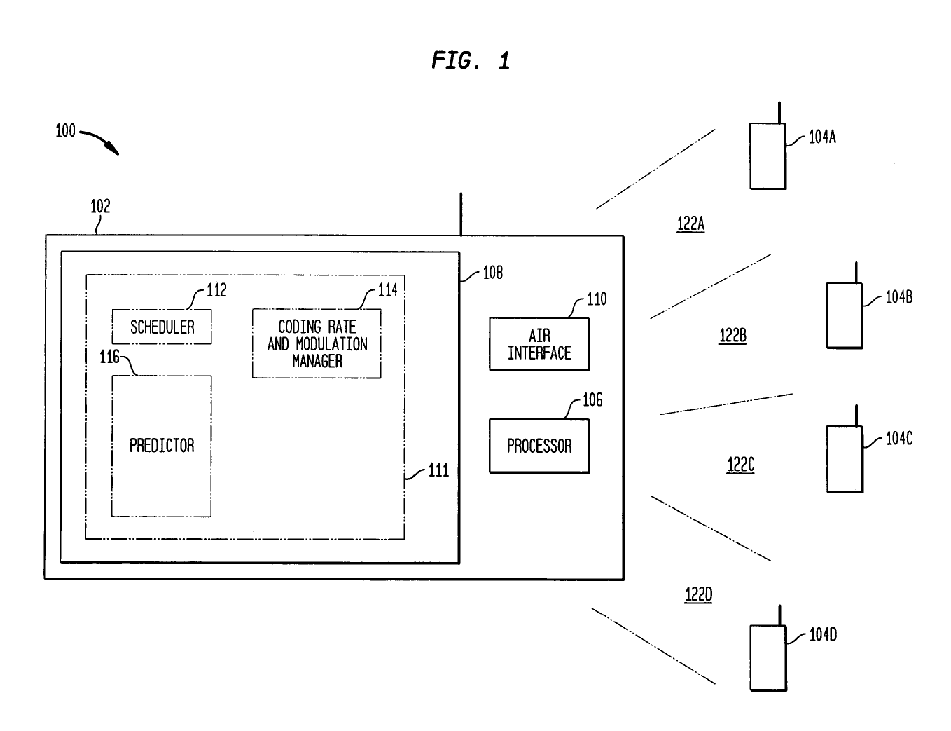

FIG. 1 illustrates a wireless system 100, comprising a plurality of base stations such as the base station 102, with each of the base stations serving a plurality of mobile units such as the mobile units 104A-104D. For simplicity of illustration, only a single base station 102 and four mobile units 104A-104D are illustrated here, but it will be recognized that many base stations and many mobile units may be supported.

The base station 102 suitably includes a processor 106 and memory 108, in order to store data and perform data processing required for the operation of the base station 102. base station 102 implements an air interface 110 for receiving transmissions directed to the base station 102, for example by the mobile units 104A-104D, by other base stations or by other wireless control elements, and for transmitting signals to the mobile units 104A-104D, to other base stations and to other wireless network elements.

General principles of reception and transmission performed by the base station 102 are known in the art, and well known aspects of the operation of the air interface 110 are not described in detail here, except as required to provide context for the present invention.

In order to manage encoding and transmission of data, the base station 102 includes a scheduler 112 to manage transmission to each of the mobile units 104A-104D. The scheduler 112 makes determinations as to which mobile unit or units are to be served next, based on the channel quality experienced by each mobile unit and other considerations such as available power and bandwidth and quality of service requirements. The scheduler 112 also determines whether a unit of data, such as a codeword, is to be sent as a single transmission or as a sequence of transmissions.

The base station 102 also includes a coding rate and modulation manager 114. The coding rate and modulation manager 114 encodes data for transmission to the selected mobile unit. The unit of data may suitably be a codeword, that is, a sequence of bits including data bits and error correction bits. The coding rate and modulation manager 114 determines the coding rate at which a unit of data is to be encoded and transmitted based on direction received from the scheduler 112. In addition, also based on direction from the scheduler 110, the coding rate and modulation manager 114 prepares each unit of data for transmission. Depending on determinations made by the scheduler 112, typically based on determinations or predictions of the quality of the channel over which transmission is to be made, the coding rate and modulation manager 114 either prepares a unit of data such as a codeword to be transmitted at once, during a single time interval, or in portions, over a number of time intervals. The air interface 110 encodes data and transmits an RF signal representing the data.

In order to manage transmission, the scheduler 112 needs to receive information indicating the quality of the channels over which transmission is to be made. Transmission to the mobile units 104A-104D is made over the transmission channels 122A-122D, respectively. Each of the channels 122A-122D provides a particular level of channel quality at any particular time, with the channel quality being conveniently defined by the signal to noise ratio provided by the channel. In order to provide the scheduler 112 with the information necessary to manage transmission and encoding, the base station 102 receives a feedback signal from each of the mobile units 104A-104D, with the feedback signal from each module providing information relating to the channel quality experienced by that mobile unit. The feedback signal is received by the air interface 110, and channel quality information is extracted from the feedback signal and supplied to the scheduler 112. The channel quality information for each channel is typically presented as a value indicating the signal to noise ratio experienced by the mobile unit. Each of the mobile units 104A-104D sends a feedback signal once every time interval, with the frequency with which the feedback signals are sent, and the nature and format of the information provided by the feedback signals, being determined by the wireless standard being used by the network 100.

As an example, in the EV-DV standard, each mobile unit evaluates the quality of the signal to noise ratio that it is experiencing and uses dynamic quantization to prepare a four bit channel quality indicator. The mobile unit sends to the base station a feedback signal containing the indicator 800 times per second, that is, every 1.25 ms.

In wireless systems, transmission from the base station to the mobile unit takes place during a timeslot, that is, a specified interval of time defined by the standard under which the wireless system is operating. In the EV-DV standard, for example, the duration of a timeslot is 1.25 ms. A progressively more refined version of a codeword, which determines the message being sent, is transmitted over a succession of timeslots. This transmission continues until either a positive acknowledgement is received or a maximum number of slots is reached and an error declared. The scheduler 118 needs to manage transmission in order to achieve desired objectives, for example maximizing throughput by choosing the one of the mobile units 104A-104D that is experiencing the most favorable channel quality and setting the amount of data to be transmitted during a particular timeslot so that the transmission can be completed within the timeslot, given the channel condition prevailing during the transmission. For example, a favorable channel can accommodate a longer codeword, while an unfavorable channel may be able to accommodate only a shorter codeword. In addition, or as an alternative, a codeword may be transmitted over an unfavorable channel in segments. Segments of a codeword may be transmitted in consecutive timeslots, or transmissions to other mobile units may intervene between transmission of segments, depending on the channel conditions prevailing during transmission and on the particular protocol being used to schedule transmissions.

The feedback signal provides information indicating the signal to noise ratio being experienced by the mobile unit at the time the evaluation is made. However, transmission from the base station 102 to one of the mobile units 104A-104D will frequently occur some time after the feedback signal is transmitted, either because time is required to prepare and send a transmission, or because a delay is necessary between the time the feedback signal is received and the time a transmission of interest is to be sent. Therefore, the measured channel quality indicated by the feedback signal often will not prevail when an actual transmission is received by the mobile unit sending the feedback signal.

In order to provide an estimate of the signal to noise ratio that will be experienced by the various mobile units when the transmission is actually made, the base station 102 includes a channel predictor 116. The channel predictor 116 makes a prediction about the channel condition that will be experienced by each of the mobile units 104A-104D during a timeslot of interest. The prediction may need to account for the channel condition over one or several timeslots, depending on whether the channel is changing slowly or rapidly. If the channel is changing slowly, on the order of a few Hz, the predictor 116 can predict the channel condition several milliseconds ahead, so that channel conditions over the transmission of an entire codeword can be predicted with reasonable accuracy.

However, if the channel is changing more rapidly, on the order of tens of Hz, prediction of the channel condition is difficult or impossible for any period significantly in the future, for example at an interval of more than one or two timeslots. In this case, the mean and variance of the channel condition can be estimated, and this information can be provided to the scheduler 112. Therefore, the predictor 116 is adapted to operate so that it tends to assign more importance to the mean and variance of the sequence of channel conditions occurring in a rapidly changing channel and more importance to specific prediction computations for a more slowly changing channel.

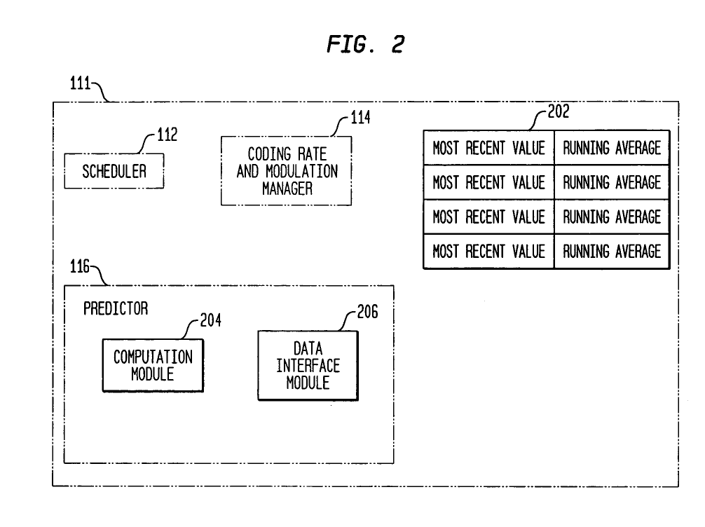

FIG. 2 illustrates additional details of the transmission processing module 111, showing the various elements used to store and process information in order to predict channel conditions.

The transmission module 111 includes a channel indicator database 202. Channel prediction as implemented by the system 100 employs the analysis of past channel condition information to make predictions about future channel conditions. Therefore, the transmission processing module 111 receives each channel indicator and stores required information in the database 202. Suitably, prediction employs a most recent indicator value as well as a running average of past indicator values. In such a case, for each of the channels 122A-122D, therefore, the database 202 might store a most recent indicator value representing the channel condition most recently experienced by the mobile unit, and associated with the time interval at which the channel condition occurred. In addition, the database might store a mean channel condition indicator value for each channel, representing a running average of all channel condition indicators so far received, with the average being computed by a computation module 204 and stored in the database 202. Suitably, the database 202 is updated whenever a new channel indicator is received, with the newly received channel indicator replacing the previously stored indicator value and the newly received value being used to update the mean value. The computation module 204 uses the most recent channel condition indicator value as well as the mean channel condition indicator value to make predictions about channel conditions for a time of interest. The channel predictor 116 also includes a data interface module 206, to retrieve required data, for example from the database 202, and to store results.

The channel condition indicator may be represented by a variable y, with the variable y taking on sequential values y₀, y₁, y₂, . . . , yₙ, and the value of y at time n may suitably be expressed as yₙ. If the time of interest is n, and the most recent time period for which a channel condition indicator can be obtained is time n-lag, the values sequentially stored in the database 202 are y₀, y₁, y₂, . . . , y_{n-lag}. A running average of these values is maintained and at any time of interest n, the computation module 204 receives the running average and the value y_{n-lag} and uses them to compute a value ŷₙ, which is the prediction of the value of yₙ. It will be recognized that alternative techniques of computing the mean value are possible. For example, if sufficient memory is available, each of the sequentially received channel indicator values may be maintained in the database 202 and used to compute the mean whenever the mean value is to be used in computation.

To avoid unnecessary duplication, the following discussion deals with prediction for the single channel 122A used for communicating with the mobile unit 104A, but it will be recognized that the predictor 116 receives information about and makes predictions related to the channel condition for each of the mobile units 104A-104D, and that a channel predictor such as the predictor 116 may make predictions about communication channels between a base station and a large number of mobile units.

At time n-lag, the predictor 116 predicts the value of yₙ, where lag is the prediction lag, that is, the number of timeslots between the time n-lag for which the most recent channel information is available, and the time n of interest for which the prediction is being made. For example, if the value of lag is 5, the predictor 116 predicts the channel condition for a time 5 timeslots in the future from the time n-lag for which the most recent information is available. The computation module 204 may employ all of the values in the sequence up until n-lag in order to compute or estimate statistical parameters to be used in predicting the channel condition at time n.

The computation module 204 computes the predicted channel condition ŷₙ, using the following equation:
ŷₙ=w·ŷ_{n-lag}+(1−w)·y_{n-lag} (1)
where \overline{y}_{n-lag} is an estimate at time n-lag of the mean value of y and wε[0,1] is the relative weight given to the mean value as compared to the most recent value. The weight w is adapted to track the underlying channel statistics and the lag, and the analysis of the statistics and estimation of the weight w is described in further detail below.

The mean and variance of the y sequence, at any time x of interest, may be estimated using exponential smoothing of the first and second moments of the sequence as follows:
\overline{y}ₓ=(1−γ)\overline{y}ₓ₋₁+γyₓ (2)
vₓ(1−γ)vₓ₋₁+γy²ₓ, (3)
where γ is a smoothing coefficient.

In computing the solution to equation (1), the computation module 204 needs the value of \overline{y}_{n-lag}. The value of “x” in equation (2) is therefore “n-lag”. The computation module 204 therefore computes the solution to the following equation:
\overline{y}_{n-lag}=(1−γ)\overline{y}_{n-lag-1}+γy_{n-lag} (4)

The computation module 204 takes a running average of the sequence values from y₀ to y_{n-lag-1}, and the actual value of y_{n-lag}, and uses these values to compute the solution to equation (4). As noted above, the running average has suitably been continuously computed as each new channel indicator has been received. Once the solution to equation (4) has been computed to yield the value of y_{n-lag}, this value is then used in equation (1).

The estimate for the variance is given by
μₓ=vₓ−\overline{y}²ₓ, (5)
which is nonnegative by convexity of the quadratic function. It will be noted that when y is a stationary sequence, the above mean and variance estimates are unbiased whenever the initial estimates \overline{y}₀ and v₀ are unbiased. This may be achieved, for example, by setting \overline{y}₀=y₁ and v₀=y²₁.

In the case of channel prediction in a wireless system, it will very frequently be convenient to choose a fixed value for the smoothing coefficient γ. This choice is motivated by knowledge of the underlying physical phenomena leading to time variation in the mean and variance of the y sequence. In a typical wireless environment, a more rapid variation in the channel will be due to Rayleigh fading, while a slower variation will be due to log-normal shadowing. The former has a frequency ranging from a few Hz to a few hundred Hz, depending on the speed at which the mobile unit is traveling. A slower channel variation is typically of the order up to 1 Hz. In order to track the mean of the channel variation, it is necessary to average over the faster variation that occurs as a result of Rayleigh fading. The slower variation, on the other hand, should be specifically tracked. As an example, as noted above, the EV-DV standard calls for the feedback signal indicating the channel quality experienced by the mobile unit to be received by the base station 800 times per second, or every 1.25 ms. An appropriate choice for the value of the smoothing coefficient γ for use with the prediction technique described above and used with the EV-DV standard is 0.01.

Many alternative choices are possible for selection of the values of the smoothing coefficients. For example, it is possible to adapt the smoothing coefficient for a given value of lag, based on knowledge of the specific environment. For example, it is possible to adapt the smoothing coefficient so as to minimize the mean square prediction error at a specified value for lag.

In order to use equation (1) to compute the predicted channel quality, it is necessary to assign a weight to the variable “w”. In a nonvarying channel, an optimal value of “w” can be calculated. However, a single optimal value of “w” cannot be calculated for a time varying channel. The computation module 204, therefore, employs an adaptive technique to calculate values for “w”. Advantageously, the value of “w” can be computed by the following equation:
wₙ=[wₙ₋₁+ε(yₙ−ŷₙ(y_{n-lag}−\overline{y}_{n-lag}]⁺, (6)
where ε is adaptation step size and [x]⁺ denotes the projection of x onto [0,1].

Equation (6) is an adaptation of the Kiefer-Wolfowitz algorithm, and minimizes the mean square prediction error.

The underlying channel statistics may vary at a rate of up to 1 Hz, and the optimum value of w will vary at the same rate as the channel statistics. The adaptation step size E can be chosen accordingly. The expression (yₙ−ŷₙ) is the error value, that is, the difference between the actual channel condition value for time n and the value of the prediction for time n, and the expression (y_{n-lag}−\overline{y}_{n-lag}) is the gradient of the error value with respect to w.

Equation (6) is used if adaptation is to be performed at every timeslot. As an alternative to adaptation at every timeslot, the computation module 204 may use a block based adaptation rule to perform adaptation after every block of M time steps. The adaptation is performed using the following rule:

$${w}_{n} = {[ {w}_{n - 1} + ε \cdot \frac{1}{M} {\sum }_{m = n - M + 1}^{n} ( {y}_{n} - {\hat{y}}_{n} ) ( {y}_{n - 1} - {\overline{y}}_{n - 1} ) ]}^{+} , \\ when n = kM , and {w}_{n - 1} otherwise . \qquad ( 7 )$$

The use of a block based adaptation rule such as equation (6) not only reduces computational overhead but also reduces the variance in the computation of w, without sacrificing tracking performance. The block size M is the number of timeslots that elapses between adaptations, and is chosen so as to achieve an acceptable speed of adaptation to the time varying channel statistics and a reasonably small variation in the value of w. Simulation results suggest that a block size of 100 and an adaptation step size of 0.002 perform well in most wireless environments.

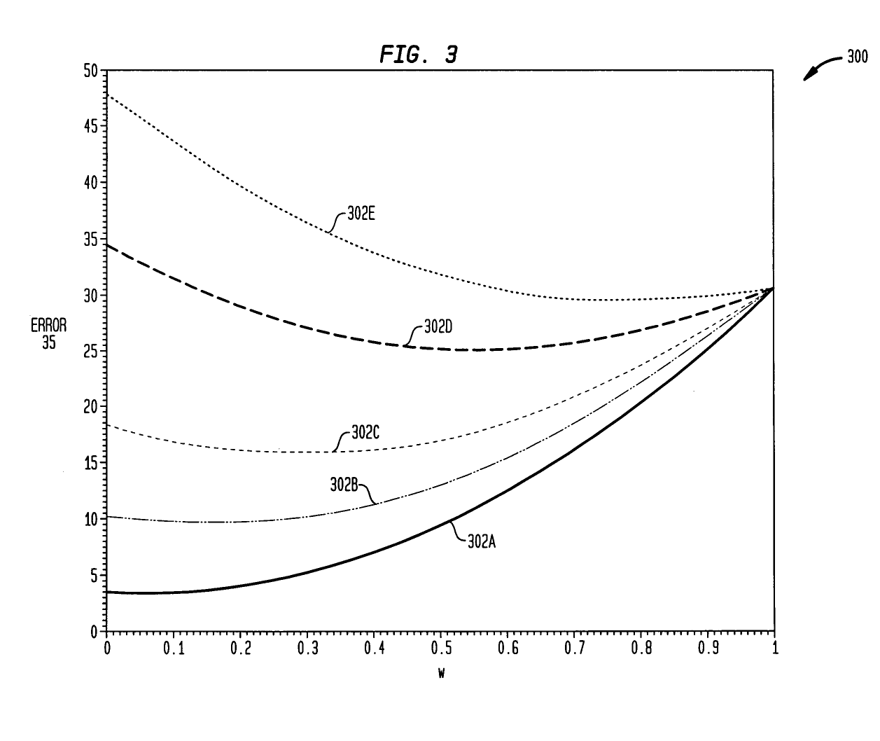

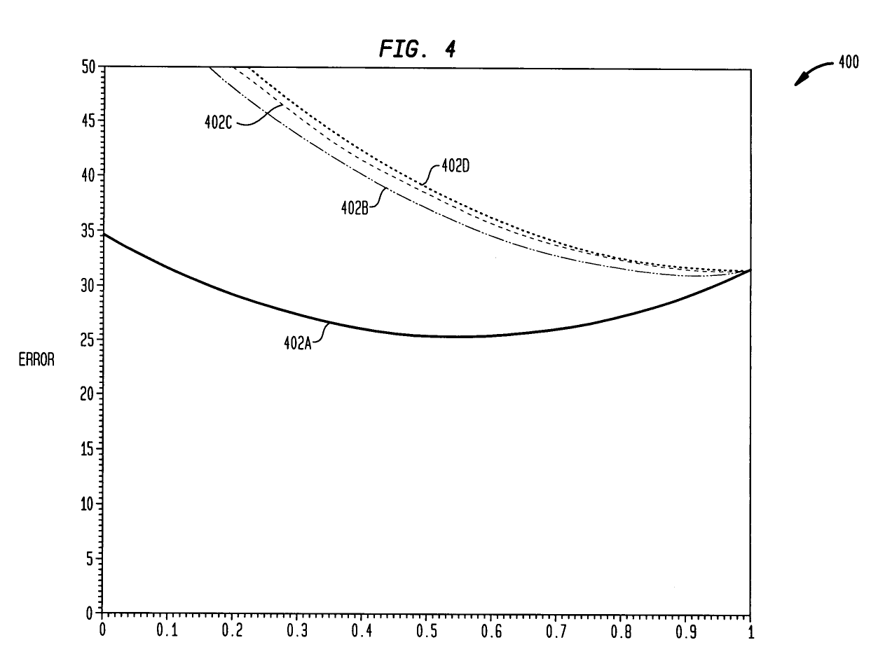

FIGS. 3 and 4 illustrate graphs showing the effect of the value of w, or weight, on the performance of the channel condition prediction performed by the predictor 116. FIG. 3 is a graph 300 comprising a set of curves 302A-302E, plotting prediction error against w, or weight, for fading frequencies of 5, 10, 15, 25 and 35 Hz, respectively, with a prediction lag of 5 timeslots. It will be seen that for lower fading frequencies, representing a more slowly changing channel, a lower value for w yields a better error performance, while for higher fading frequencies, representing a more rapidly changing channel, a higher value for w yields the better performance. In a slowly changing channel, a more specific prediction can be made, while for a more rapidly changing channel, better prediction results from the use of a mean value.

FIG. 4 is a graph 400 comprising a set of curves 402A-402D, plotting prediction error against w, or weight, for fading frequencies of 5, 10, 15 and 25 Hz, respectively, with a prediction lag of 25 timeslots. In this case, fading occurs relatively rapidly with respect to the speed of prediction, so that a higher value for w tends to yield a better error performance in each case.

A system using techniques similar to those described above provides good results compared to various other known techniques. The table below presents various scenarios that may easily be encountered in wireless communication, and the fading frequency presented by each scenario.

| Speed (km/h) | Activity | Fading Frequency (Hz) | |
|---|---|---|---|
| 3 | Walking | 5.78 | (5) |
| 15 | Cycling | 26.39 | (25) |
| 30 | Driving (in town) | 52.78 | (50) |
| 100 | Driving (freeway) | 175.93 | (175) |

The following table compares prediction performed according to the present invention (w-pred.) against various other techniques that are usable under real conditions, as well as other techniques that are shown here so as to provide insight under simulated conditions. In real conditions, the channel statistics are not known and are time varying. Techniques usable under these conditions are the w-predictor, the use of the most recent channel condition (MR) and an adaptive least squares predictor (Adapt.). The theoretical techniques shown here for additional comparison are pre-optimized first and second order predictors (Opt. 1 and Opt. 2), and a conditional mean predictor (Cond. mean). The results presented here are shown for a lag of 5 timeslots. The smoothing parameter for the mean component of the w-predictor was taken to be 0.01 and the block size for adaptation to be 100. With a block size of 100, adaptation occurs every 100 timeslots. Under the EV-DV standard, with a timeslot size of 1.25 ms, adaptation occurs every 125 ms. The adaptation factor was taken to be 0.002. The corresponding parameter for the adaptive least-squares predictor was 0.001. The results are normalized to a fading variance of approximately 31.02.

| Speed | w-pred. | MR | Opt. 1 | Opt. 2 | Adapt. | Cond. Mean |
|---|---|---|---|---|---|---|
| 3 | 0.12 | 0.12 | 0.12 | 0.18 | 0.18 | 0.10 |
| 15 | 0.85 | 1.16 | 0.83 | 0.95 | 0.95 | 0.78 |
| 30 | 1.03 | 1.98 | 1.02 | 1.08 | 1.08 | 1.02 |
| 100 | 1.02 | 1.90 | 1.02 | 1.04 | 1.04 | 1.02 |

The conditional-mean predictor outperforms all other predictors except the optimal second order fixed predictor at low frequencies. The most recent value does well at low fading frequencies, but its performance deteriorates as expected when the fading frequency increases. The w-predictor outperforms the adaptive predictor and is comparable with the first order optimal fixed predictor for most frequencies. This is marginally worse than the optimal second order fixed predictor. Also, the performance of the most recent value predictor degrades to around twice the variance. The mean square error of the conditional mean predictor is slightly higher than 1 at high fading frequencies, possibly due to the conditional mean being constructed from a table, which introduces rounding and sampling errors.

The following table shows results for the predictors and conditions previously discussed, but with a lag of 25 timeslots.

| Speed | w-pred. | MR | Opt. 1 | Opt. 2 | Adapt. | Cond. Mean |
|---|---|---|---|---|---|---|
| 3 | 0.91 | 1.14 | 0.88 | 0.75 | 1.24 | 0.76 |
| 15 | 1.06 | 1.99 | 1.03 | 1.02 | 1.31 | 1.02 |
| 30 | 1.05 | 2.04 | 1.03 | 1.02 | 1.21 | 1.03 |
| 100 | 1.03 | 2.03 | 1.03 | 1.02 | 1.09 | 1.03 |

The optimal fixed predictor now slightly outperforms the w-predictor. The adaptive predictor still does not perform as well as the w-predictor. There is a small deterioration in performance between the conditional mean and the w-predictor.

Further comparisons were conducted between the prediction technique used by the predictor 124 and prior art techniques. A simulation was conducted using a Jakes model with a time varying mean. The model employed log normal shadowing, a frequency f_{shadow} of 0.5 Hz, and a standard deviation of 6 dB. The model produced a sequence having a time correlation given by J₀(2πf_{shadow}τ), where J₀(•) is the 0-th order Bessel function.

The following tables give the normalized mean square errors of the w-predictor, prediction using the most recent value and the adaptive least squares predictor, at lags 5 and 25, respectively. The results provided by the optimal fixed and conditional mean predictors are not given because their performance is the same as in the example given above.

| Speed | w-pred. | MR | Adapt. |
|---|---|---|---|
| 3 | 0.13 | 0.12 | 0.21 |
| 15 | 0.88 | 1.16 | 1.40 |
| 30 | 1.11 | 1.98 | 1.70 |
| 100 | 1.10 | 1.90 | 1.53 |

| Speed | w-pred. | MR | Adapt. |
|---|---|---|---|
| 3 | 0.96 | 1.15 | 2.20 |
| 15 | 1.18 | 1.99 | 2.54 |
| 30 | 1.17 | 2.05 | 2.48 |
| 100 | 1.15 | 2.03 | 2.29 |

The w-prediction performed by the computation module 204 continues to perform well, and has only a slightly larger mean square error than in the stationary case. The performance of the adaptive least squares predictor, however, degrades significantly, especially at higher lag.

The following table compares the performance of the w-prediction performed by the computation module 204 against prediction using the most recent channel condition and the adaptive least squares predictor, using a Jakes model with a time varying mean and fading frequency. The fading sequence used has a Doppler frequency of 5 Hz for 5 seconds, jumps instantaneously to 10 Hz for 5 seconds, and falls back to 5 Hz for a final 5 seconds.

| Lag | w-pred. | MR | Adapt. |
|---|---|---|---|
| 5 | 0.29 | 0.30 | 0.40 |
| 25 | 1.01 | 1.73 | 1.38 |

The following table shows results for an actual scenario. These measurements were carried out in a field trial for a minimum input minimum output (MIMO) channel estimation and capacity study. The original measurements were for a configuration with 16 transmit and 16 receive antennas. For the channel prediction experiments, a trace from a single transmit antenna and receive antenna pair was used. The trace had 1621 samples, with a sampling interval of 3 milliseconds. The following table shows the performance of various predictors at different lags normalized by the variance of the measurements, which was found to be 8.86. The parameters of the various predictors were taken as specified earlier, and no attempt to tune them was made.

| Lag | w-pred. | MR | Adapt. |
|---|---|---|---|
| 1 | 0.61 | 0.70 | 0.86 |
| 3 | 1.14 | 1.80 | 4.90 |
| 5 | 1.17 | 1.88 | 9.46 |
| 25 | 125 | 2.07 | 49.29 |

As the mean square error values indicate, the w-predictor provides good performance for a wide range of lag values, while the performance of the adaptive predictor falls dramatically at higher lags.

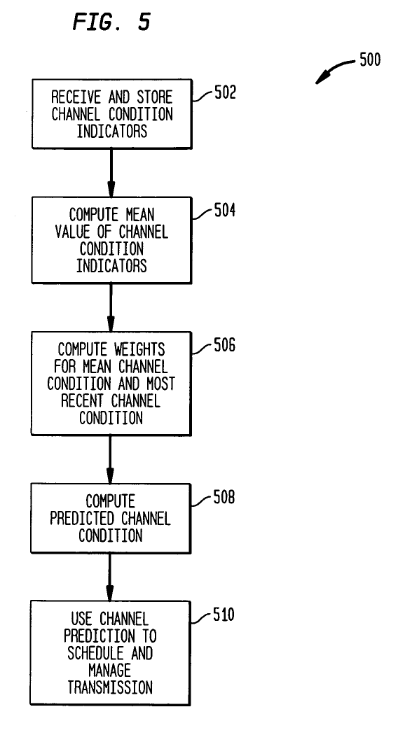

FIG. 5 illustrates a process 500 of data communication according to an aspect of the present invention. The process 500 may suitably be performed by a predictor such as the predictor 124 of FIGS. 1 and 2, employed by a base station such as the base station 102 of FIG. 1, in order to provide data transmission services. The steps of the process 500 are preferably performed in parallel for each of a plurality of mobile units being served by a base station, such as the mobile units 104A-104D of FIG. 1. At step 502, a series of channel condition indicators are received from a mobile unit and stored. At step 504, the mean value of the channel conditions as indicated by the channel condition indicators is computed. At step 506, a weight is computed for the most recent channel condition indicator value and the mean channel condition indicator value, in order to strike a balance between the channel condition indicated by the most recent channel condition indicator value and the mean channel condition. At step 508, a predicted channel condition for a time of interest is computed based on a balancing of the most recent channel condition indicator value against the mean channel condition indicator value. At step 510, the channel condition prediction is used to schedule and manage transmission, for example to select a mobile unit for service, to choose codeword size for transmissions and to perform any other desired operation for which prediction of channel condition is useful.

While the present invention is disclosed in the context of a presently preferred embodiment, it will be recognized that a wide variety of implementations may be employed by persons of ordinary skill in the art consistent with the above discussion and the claims which follow below. For example, it will be recognized that the technique discussed above can be extended to higher order prediction, at a cost of some added complexity. Instead of basing prediction on only the mean channel indicator value and the most recent value, it is possible to make a prediction based on the mean value, the most recent value and additional recent values, with appropriate weightings being given to the mean value and the various recent values.

1. A communication system, comprising:
a mobile unit operative to transmit periodic channel condition indicator signals, each indicator signal including information relating to a signal to noise ratio being experienced by the mobile unit; and
a base station operative to transmit data to the mobile unit, the base station being operative to receive the indicator signals from the mobile unit and generate a channel condition prediction reflecting a channel condition expected to be experienced by the mobile unit, the channel condition prediction being based on a balanced estimate using the most recent channel condition indicator value and a mean of past channel condition indicator values.

2. The system of claim 1, wherein the channel condition prediction assigns a greater emphasis to the mean of past channel condition indicator values during rapidly changing channel conditions and a greater emphasis to the most recent channel condition indicator values during more slowly changing channel conditions.

3. The system of claim 2, wherein the channel condition prediction is computed by assigning a weight to the most recent channel condition indicator value and the mean of past channel condition indicator values, the relative weights being influenced by the rate of change in the channel condition.

4. The system of claim 3, wherein the weights assigned to the most recent channel condition indicator value and the mean channel condition indicator value depend on a gradient of past channel condition indicator values.

5. The system of claim 4, wherein the mobile unit transmits a channel condition indicator to the base station at each timeslot, a timeslot being a time period during which communication takes place, as defined by a standard under which the system operates, and wherein the base station receives a channel condition indicator value during each timeslot, the base station maintaining an average of channel condition indicator values, the base station computing a channel condition prediction during each timeslot, each channel condition prediction reflecting an expected channel condition expected to prevail at the mobile unit a specified number of timeslots in the future from the most recent channel condition.

6. The system of claim 5, comprising a plurality of mobile units, each transmitting periodic channel condition indicators to the base station, wherein the base station computes periodic channel condition predictions for each mobile unit and uses the future channel condition predictions to select a mobile unit for service and to select a codeword size for transmission to each mobile unit.

7. A base station for communicating with a plurality of mobile units, comprising:
an air interface for receiving transmissions from the mobile unit, periodic ones of the transmissions including a channel condition indicator providing information relating to a signal to noise ratio being experienced by the mobile unit; and
a predictor for receiving channel condition indicator values and generating future channel condition predictions reflecting a future channel condition expected to be experienced by each mobile unit, each of the future channel condition predictions being based on a balanced estimate using the most recent channel condition indicator value for the mobile unit and a mean of past channel condition indicator values for the mobile unit.

8. A predictor for generating a channel condition prediction for each of a plurality of mobile units, comprising:
a data interface module for retrieving channel condition indicators, each channel condition indicator reflecting past channel conditions experienced by one of the plurality of mobile units; and
a computation module for computing a mean channel condition indicator value for each mobile unit, based on a mean of channel condition indicators associated with the mobile unit and for generating a channel condition prediction based on a balanced estimate using the most recent channel condition indicator value and a mean of past channel condition indicator values.

9. The predictor of claim 8, wherein the computation module assigns a greater emphasis to the mean of past channel condition indicator values during rapidly changing channel conditions and a greater emphasis to the most recent channel condition indicator values during more slowly changing channel conditions.

10. The predictor of claim 9, wherein the computation module employs the mean channel condition indicator value, the most recent value and additional recent values to generate the channel condition prediction.

11. A method of channel condition prediction, comprising the steps of:
receiving and storing a succession of channel condition indicators from each of a plurality of mobile units, each channel condition indicator received from a mobile unit reflecting a channel condition reflected by the mobile unit; and
generating a channel condition prediction for a time of interest for each mobile unit, each channel condition prediction reflecting a balanced estimate using the most recent channel condition indicator value and a mean of past channel condition indicator values.

12. The method of claim 11, wherein each channel condition prediction reflects a greater emphasis on the mean of past channel condition indicator values during rapidly changing channel conditions and a greater emphasis on the most recent channel condition indicator values during more slowly changing channel conditions.

13. The method of claim 12, wherein the step of generating the channel condition predictions includes assigning a weight to the most recent channel condition indicator value for each mobile unit and the mean of past channel condition indicator values for each mobile unit, the relative weights being influenced by the rate of change in the channel condition.

14. The method of claim 13, wherein the weights assigned to the most recent channel condition indicator value and the mean channel condition indicator value depend on a gradient of past channel condition indicator values.

15. The method of claim 14, further comprising a step of managing data transmission using the channel condition predictions.
